(19) United States
(12) Patent Application Publication
(10) Pub. No.: US 2016/0131517 A1
(43) Pub. Date: May 12, 2016

(54) WEIGHING SYSTEMS HAVING LOCATION CALIBRATION CAPABILITY

(71) Applicants: AKA ADVANCED TECHNOLOGIES LTD., Beit Shemesh (IL); SHEKEL SCALES CO. (2008) LTD., Kibbutz Beit Keshet (IL)

(72) Inventor: Shimon MIZRAHI, Beit Shemesh (IL)

(21) Appl. No.: 14/896,779

(22) PCT Filed: Jun. 10, 2014
(86) PCT No.: PCT/IB2014/062107

§ 371 Date: Dec. 8, 2015

Related U.S. Application Data
(60) Provisional application No. 61/833,148, filed on Jun. 10, 2013.

(51) Int. Cl. G01G 23/01

(52) U.S. Cl. CPC G01G 23/01

(57) ABSTRACT

An integrated weighing system having a calibration system for calibrating the weighing system based on geographical location information, and optionally, based on barometric information.

### This application draws priority from U.S. Provisional Patent Application Ser. No. 61/833,148, filed Jun. 10, 2013, which is incorporated by reference for all purposes as if fully set forth herein.

FIELD AND BACKGROUND OF THE INVENTION

The present invention relates to weighing systems, apparatus and methods, and more particularly, to weighing systems and apparatus having automatic calibration capabilities, and methods of providing such automatic calibration capabilities.

The strength of the gravitational field (or free-fall acceleration) at the Earth's surface, g, is approximately 9.81 m/s², and is directly related to the weight exhibited by objects on Earth, which may be calculated using the equation F=m•g (force=mass X gravity).

The precise magnitude of the Earth's gravitational field depends on the particular location on the surface of the Earth, e.g., latitudinal positioning. In fact, the magnitude of the exerted gravitational force may vary between the equator and the North or South Poles by about 1%. This variation may negatively impact the accuracy of weighing systems. It will be appreciated by those of skill in the art that changing the geographical location of a sensitive weighing system (e.g., configured with at least 1000 divisions) may appreciably compromise weighing accuracy. Thus, calibration of such weighing systems may be required. Such calibration may be carried out by a technician trained to use a calibration unit, or trained to compare the weight results of the system with the weight results of another weighing system that has already calibrated in accordance with the geographical location thereof.

Alternatively, the calibration of the system may be carried out by calculating the precise strength of the gravitational field at the particular location of the system. This may be accomplished using known equations that take into consideration the latitude as well as the altitude of the particular location. For example:

$${g}_{φ , h} = 9.780327 [ \begin{matrix}( 1 + 0.0053024 {sin}^{2} φ - 0.000058 {sin}^{2} 2 φ ) - \\ 3.155 {10}^{- 7} h\end{matrix} ] \frac{m}{{s}^{2}} \qquad ( Eq . 1 )$$

gφ,f being the acceleration in m/s² at a latitude φand an altitude h (in meters).

The existing systems, apparatus and methods notwithstanding, the present inventor has recognized a need for improved weighing systems and weighing apparatus having automatic calibration capabilities, and methods of providing such automatic calibration capabilities.

### SUMMARY OF THE INVENTION

According to some teachings of the present invention there is provided an integrated weighing system having a location calibration capability, the system including: (a) a basic weighing system including: (i) at least one weighing element adapted to produce weight information; and (ii) a weighing interface adapted to receive the weight information, and to process the weight information to produce a weight indication; (b) a calibration system, associated with the basic weighing system, the calibration system including a radio receiver arrangement adapted to receive radio signals broadcasted by at least one broadcasting radio station and to receive radio station identity information with respect to each broadcasting radio station; and (c) a processor adapted to produce location-sensitive information with respect to the processor based at least partly on the radio station identity information; and to communicate the location-sensitive information to the weighing interface, the weighing interface further adapted to utilize the location-sensitive information, such that the weight indication is a location-calibrated weight indication.

According to another aspect of the present invention there is provided a location-based weight calibration system for location-based calibration of a weighing system, the calibration system including: (a) a radio receiver arrangement adapted to receive radio signals broadcasted by at least one broadcasting radio station and to receive radio station identity information with respect to each broadcasting radio station; and (b) a processor adapted to: (i) based at least partly on the radio station identity information, produce a function dependent on a local gravitational field strength (g_{local}) that is local with respect to the processor; and (ii) communicate the function to a weighing interface of the weighing system, the calibration system being adapted to be associated or physically connected to the weighing system.

According to yet another aspect of the present invention there is provided a method for improving weighing accuracy of a weighing system, the method including: (a) receiving radio signals from the broadcasting radio station, the signals including radio station identity information; (b) determining a location of the radio station, based at least partly on the radio station identity information; (c) producing an estimated geographical location for the weighing system, based on the location of each radio station; and (d) calculating a local gravitational field strength in a vicinity of the integrated weighing system, using the estimated geographical location.

According to yet another aspect of the present invention there is provided a method for improving weighing accuracy of a weighing system, the method including: (a) providing the integrated weighing system according to any one of claims 1 to 10; (b) receiving radio signals from at least one broadcasting radio station, the signals including the radio station identity information; (c) determining a location of the radio station, based at least partly on the radio station identity information; (d) producing an estimated geographical location for the integrated weighing system, based on the location of each radio station; and (e) utilizing the estimated geographical location to obtain a location-calibrated weight indication.

According to further features in the described preferred embodiments, the calibration system further includes a barometric sensor adapted to communicate barometric information pertaining to an ambient environment to the processor.

According to still further features in the described preferred embodiments, the processor is further adapted to communicate the barometric information to the weighing interface, the weighing interface further adapted to utilize the barometric information, such that the weight indication is a pressure-calibrated weight indication.

According to still further features in the described preferred embodiments, the calibration system is physically attached to the basic weighing system.

According to still further features in the described preferred embodiments, the integrated weighing system further includes a unitary structure housing both the basic weighing system and the calibration system.

According to still further features in the described preferred embodiments, the location-sensitive information is dependent on a local gravitational field strength (g_{local}).

According to still further features in the described preferred embodiments, the location-sensitive information includes a local gravitational field strength calibration factor.

According to still further features in the described preferred embodiments, g_{local} is associated with a specific location of the integrated weighing system.

According to still further features in the described preferred embodiments, g_{local} is associated with a general region of the integrated weighing system.

According to still further features in the described preferred embodiments, the radio receiver arrangement includes a tuner adapted to perform a frequency sweep.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

### In the drawings:

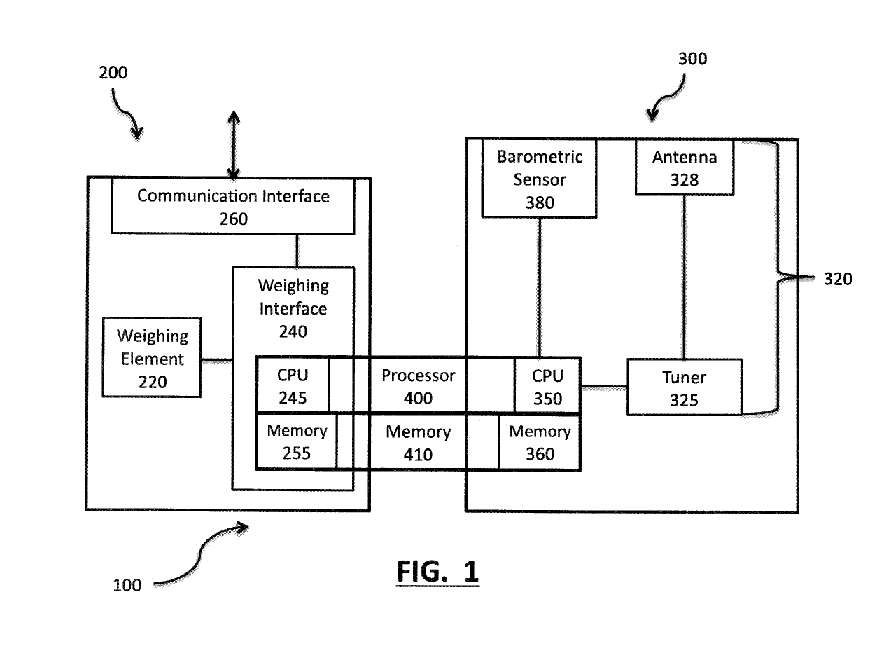

FIGURE 1 is a schematic block diagram of an exemplary integrated weighing system having a location calibration capability, according to an aspect of the present invention.

### DESCRIPTION OF THE PREFERRED EMDODIMENTS

The principles and operation of the weighing systems having automatic calibration capabilities, and methods of providing such automatic calibration capabilities, according to various embodiments of the present invention, may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

FIGURE 1 is a schematic block diagram of an exemplary integrated weighing system 100 having location calibration capability, according to an aspect of the present invention. Integrated weighing system 100 may include a basic or conventional weighing system 200 having at least one weighing element 220 adapted to produce weight information, and a weighing interface 240 adapted to receive this weight information, and to process this weight information to produce a weight indication. Associated with weighing interface 240 is a processor 400. Processor 400 may be disposed within weighing interface 240 as shown with an exemplary central processing unit (CPU) 245. Weighing interface 240, and/or CPU 245 (or more generally, processor 400), may be communicative with a communication interface 260, which may also communicate with an external environment or user. As will be appreciated by those of skill in the art, communication interface 260 may include an input unit and/or an output unit. A display may form part of communication interface 260. Associated with weighing system 200 is a weight calibration system 300.

Weight calibration system 300 may include a radio receiver arrangement 320 adapted to receive radio signals broadcasted by at least one, and preferably more than one, broadcasting radio station, and to receive radio station identity information with respect to each of these radio stations. Radio receiver arrangement 320 may include a tuner or receiver 325, and an antenna 328 operatively connected thereto. Tuner or receiver 325 may be adapted to effect frequency sweeps or radio station scans, as will be readily understood by those of skill in the art. Weight calibration system 300 may include a processor such as CPU 350, which may be adapted to produce location-sensitive information with respect to the specific location or general location (e.g., city, county, or province) of CPU 350, based on the radio station identity information received by tuner 325, and to communicate this location-sensitive information to weighing interface 240 within weighing system 200. CPU 350 may form a part of processor 400.

In some embodiments, the location-sensitive information may include, or consist essentially of, a local (estimated or calculated) gravitational field strength (g_{local}). As intimated above, the location-sensitive information may be with respect to the specific location of system 100, in which case, an equation such as Eq. 1 may be utilized; or a general location, such as a region or province within a country, for example, a region in which the local code adopts a regional (constant) value for g_{local}.

In some embodiments, the location-sensitive information may be an absolute value of g_{local}, or a function or coefficient for correcting the weight indication. For example, a particular basic weighing system may have been pre-calibrated at the factory using a gravitational field strength (g_{pre-calibrated}) associated with a particular latitude. In such a case, the instant system may produce a calibration factor or coefficient based on g_{local} divided by g_{pre-calibrated}. The corrected weight indication would equal the measured weight multiplied by this calibration factor or coefficient.

In some embodiments, the location-sensitive information may be location information or estimated location information, for example, radio station identity information, which then undergoes processing (e.g., by CPU 245) to produce g_{local} or a calibration factor therefor.

It will be appreciated that weight calibration system 300 may be able to receive radio signals even when system 300 is located inside a building, under a roof, or in other sheltered regions in which the GPS reception is poor, insufficient, or substantially non-existent.

Weighing interface 240 may be further adapted to utilize this location information to calibrate or otherwise correct weight information produced by weighing element 220, such that the weight indication produced (e.g., displayed and/or stored) by integrated weighing system 100 is location calibrated.

Processor 400 (or CPU 350 and/or CPU 245) may calculate the strength of the Earth's gravitational field at the particular location of the weighing system based on one or more location information estimation techniques. By way of example, the location information estimation may be performed by receiving radio signals from a plurality of standard civil radio stations.

Such stations may advantageously utilize a communications protocol in which digital information is communicated by the radio station, along with the conventional radio waves. This is particularly commonplace in FM radio broadcasts, in which various communications protocols are used, including RDS (Radio Data System) and RBDS (Radio Broadcast Data System). RDS standardizes several types of information transmitted, such as time and station identification. In the exemplary case of RDS, the digital information includes the identity of each radio station and thus the location thereof can be extracted from known databases containing location data of transmitters of various radio stations. Included in the digital information may be PI (program identification) and PS (program service). PI is a unique code that identifies the station. Every station receives a specific code with a country prefix. In the US, PI may be determined by applying a formula to the call sign of the station. PS may be a representation of the call letters or station identity name, typically having a length of 8 characters. Many commercially-available, RDS-capable receivers display this information and, if the station is stored in the presets of the receiver, such RDS-capable receivers may cache this information along with the frequency and other details associated with that preset. RDS information typically includes information that enables identification of the specific transmitter that is transmitting the radio waves.

The location of the transmitter may be stored in a memory or database 410. Memory or database 410 may be network based (e.g., cloud/internet based, or intranet based), in which case, integrated weighing system 100 may be adapted to communicate with the network. Memory or database 410 may be disposed in an external memory or hard-disk such as a flash memory stick, in which case, integrated weighing system 100 may be adapted to interface with such an external memory. At least a portion of memory 410 may be disposed within weighing system 200 (as memory 255) and/or within weight calibration system 300 (as memory 360).

Processor 400 (or CPU 350 and/or CPU 245) may access any of respective memories 410, 360, 255 to retrieve data such as radio transmitter location information.

The approximate location of the tuner, and hence, the location of the weighing system, may then be determined by various triangulation algorithms or by other algorithms that utilize location data for each of the radio stations (or transmitters) broadcasting the signals that are received by radio receiver arrangement 320.

In some embodiments, weight calibration system 300 is equipped with a barometric device such as barometric sensor 380, which may be adapted to communicate barometric information pertaining to an ambient environment to CPU 350. CPU 350 may be further adapted to communicate such barometric information to weighing interface 240, which can be adapted to utilize this barometric information. For example, the altitude of the particular location may be correlated with such barometric information. The altitude estimated from the barometric information may then be used to calculate the strength of the local gravitational field, e.g., by means of the pressure-dependent equation provided hereinabove (Eq. 1). In this case, the weight indication produced by integrated weighing system 100 is a pressure (or altitude) calibrated weight indication.

In some embodiments, the barometric pressure can be calculated based on the calculated location of the system, using existing databases containing altitude and/or barometric pressure information of various locations. Based on the calculated latitude and altitude of the system, the strength of the local gravitational field may be estimated, to produce a location calibrated and pressure (or altitude) calibrated weight indication.

In some embodiments, weight calibration system 300 may be integrated with weighing system 200 in a unitary fashion. Weight calibration system 300 and weighing system 200 may share a common equipment housing.

In some embodiments, weight calibration system 300 may be coupled to weighing system 200 when calibration of weighing system 200 is warranted or required.

As used herein in the specification and in the claims section that follows, the term “radio station”, with respect to location, is meant to include a radio transmission station.

As used herein in the specification and in the claims section that follows, the term “local gravitational field strength”, or g_{local}, is meant to include a calculated or estimated value of the actual local gravitational field strength.

As used herein in the specification and in the claims section that follows, the term “dependent on a local gravitational field strength” and the like, is meant to include a calculated or estimated value of the actual local gravitational field strength, or a calibration factor including a term containing such a calculated or estimated value.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An integrated weighing system having a location calibration capability, the system comprising:
(a) a basic weighing system including:
(i) at least one weighing element adapted to produce weight information; and
(ii) a weighing interface adapted to receive said weight information, and to process said weight information to produce a weight indication;
(b) a calibration system, associated with said basic weighing system, said calibration system including a radio receiver arrangement adapted to receive radio signals broadcasted by at least one broadcasting radio station and to receive radio station identity information with respect to each of said at least one broadcasting radio station; and
(c) a processor adapted to:
(i) produce location-sensitive information with respect to said processor based at least partly on said radio station identity information; and
(ii) communicate said location-sensitive information to said weighing interface,
said weighing interface further adapted to utilize said location-sensitive information, such that said weight indication is a location-calibrated weight indication; said calibration system being physically attached to said basic weighing system.

2. The integrated weighing system of claim 1, said calibration system further including a barometric sensor adapted to communicate barometric information pertaining to an ambient environment to said processor.

3. The integrated weighing system of claim 2, said processor further adapted to communicate said barometric information to said weighing interface, said weighing interface further adapted to utilize said barometric information, such that said weight indication is a pressure-calibrated weight indication.

4. The integrated weighing system of claim 1, said radio station station identity information including digital information.

5. The integrated weighing system of claim 1, further comprising a unitary structure housing both said basic weighing system and said calibration system.

6. The integrated weighing system of claim 1, of claim 1, said location-sensitive information being dependent on a local gravitational field strength (glocal).

7. The integrated weighing system of claim 1, said location-sensitive information including a local gravitational field strength calibration factor.

8. The integrated weighing system of claim 6, said glocal being associated with a specific location of the integrated weighing system.

9. The integrated weighing system of claim 6, said glocal being associated with a general region of the integrated weighing system.

10. The integrated weighing system of claim 1, said radio receiver arrangement having a tuner adapted to perform a frequency sweep.

11-13. (canceled)

14. The integrated weighing system of claim 4, said digital information including digital information of a system selected from the group consisting of Radio Data System (RDS) and Radio Broadcast Data System (RBDS).

15. The integrated weighing system of claim 4, said digital information including digital information selected from the group consisting of program identification (PI) information and program service (PS) information.

16. The integrated weighing system of claim 4, said processor adapted to:
based at least partly on said radio station identity information, produce a function dependent on a local gravitational field strength (glocal) that is local with respect to said processor; and
communicate said function to said weighing interface of the integrated weighing system.

17. The integrated weighing system of claim 1, said processor adapted to retrieve radio transmitter location information from a memory within the weighing system.

18. The integrated weighing system of claim 1, said calibration system including said processor.

19. The integrated weighing system of claim 4, said calibration system including said processor.

20. The integrated weighing system of claim 5, said calibration system including said processor.

21. A method for improving weighing accuracy of a weighing system, the method comprising:
(a) providing the integrated weighing system of claim 1;
(b) receiving radio signals from at least one said broadcasting radio station, said signals including said radio station identity information;
(c) determining a location of said radio station, based at least partly on said radio station identity information;
(d) producing an estimated geographical location for the integrated weighing system, based on said location of each said radio station; and
(e) utilizing said estimated geographical location to obtain a location-calibrated weight indication.

22. The method of claim 21, said determining a location of said radio station including retrieving radio transmitter location information from a memory within the weighing system.

23. The method of claim 21, said radio station identity information including digital information within a communications protocol communicated by the radio station.
